(19) United States
(12) Patent Application Publication
(10) Pub. No.: US 2008/0250269 A1
(43) Pub. Date: Oct. 9, 2008

(54) System and Method for Improving Rebuild Speed Using Data in Disk Block

(76) Inventors: Jacob Cherian, Austin, TX (US); Rohit Chawla, Austin, TX (US)

Correspondence Address: HAMILTON & TERRILE, LLP, P.O. BOX 203518, AUSTIN, TX, 78720, US

(21) Appl. No.: 11/696,855

(22) Filed: Apr. 5, 2007

(51) Int. Cl. G06F 11/00

(52) U.S. Cl. 714/6

(57) ABSTRACT

A fast rebuild mechanism by which a RAID controller is made aware of what blocks are actually in use so that only those blocks are rebuilt after a disk drive failure. The fast rebuild mechanism uses data stored in the disk metadata to indicate whether a virtual disk supports a fast rebuild and on every block to indicate whether the block has valid user data. The fast rebuild mechanism also includes functionality for an IO controller (such as storage controller) to detect whether a block has stored data to indicate that the block has valid data when the block is accessed.

### BACKGROUND OF THE INVENTION

1. Field of the Invention

The present invention relates to information handling systems and more particularly, to improving rebuild speed using data in disk block within an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It Is known to provide an information handling system with a storage system such as a Redundant Array of Inexpensive Disks (RAID) storage system. In a RAID system, the capacity from multiple disk drives attached to the RAID controller are organized into one or more virtual disks which can be accessed by a host system. The data is striped across multiple disks to improve read/write speeds, and redundant information is stored on the disks to improve the availability of data (reliability) in the event of catastrophic disk failures. The RAID storage system can typically rebuild the failed data disk via a rebuild operation by regenerating each bit of data in each track and platter of the failed disk (using its knowledge of the redundant information), and then storing each such bit in corresponding locations of a new, replacement disk.

There are a number of issues relating to rebuild operations. For example, as disk capacity increases, the time to rebuild a degraded virtual disk increases and hence the time that a customer is exposed to possible loss of data due to additional disk drive failure increases.

Known rebuild algorithms are not often aware of which blocks of a disk are in actual use (i.e, valid user data). Also, for parity based RAID systems, the number of operations for write and read operations increases significantly when the RAID virtual disk is degraded.

### SUMMARY

In accordance with an aspect of the present invention, a fast rebuild mechanism by which a RAID controller is made aware of what blocks are actually in use so that only those blocks are rebuilt after a disk drive failure is set forth. The fast rebuild mechanism uses data stored in the disk metadata to indicate whether a virtual disk supports a fast rebuild and in every block to indicate whether the block has valid user data. The fast rebuild mechanism also includes functionality for an IO controller (such as storage controller) to detect whether a block has stored data to indicate that the block has valid data when the block is accessed.

The fast rebuild mechanism also includes a maintenance operation that can be used to clear valid data block flags on blocks that are no longer in use. The operation may be manually initiated through a host based service to transmit information on what blocks are in actual use and what are not. The fast rebuild mechanism (e.g., controller firmware) then uses this information to clear the flags on the blocks that are no longer in use.

More specifically, in one embodiment, the invention relates to a fast rebuild mechanism for rebuilding a Redundant Array of Inexpensive Disks (RAID) system which includes a disk metadata storage module, a plurality of disks, an Input Output (IO) controller, and a RAID controller. The disk metadata storage module stores data disk metadata to indicate whether a virtual disk supports a fast rebuild. Each of the plurality of disks includes a plurality of blocks which include a data portion and an block information portion. The block information portion includes a valid block data indication. The IO controller determines, via the valid block data indication, whether a block has valid stored data. The RAID controller is made aware of which of the plurality of blocks are in use so that only blocks that are in use are rebuilt after a disk drive failure.

In another embodiment, the invention relates to a method for performing a fast rebuild operation on a Redundant Array of Inexpensive Disks (RAID) system. The method includes providing the RAID system with a disk metadata portion, providing each logical block within the RAID system with a user data portion and a block information portion, and indicating that a logical block has valid data via the valid block data indication. The disk metadata portion stores a fast rebuild operation indication to indicate whether the RAID system supports a fast rebuild operation. The block information portion includes a valid block data indication. Only logical blocks that contain valid data are rebuilt after a disk drive failure based upon the fast rebuild operation indication and the valid block data indications.

In another embodiment, the invention relates to an information handling system which includes a processor, memory coupled to the processor, and a Redundant Array of Inexpensive Disks (RAID) system. The RAID system is capable of a fast rebuild operation and includes a disk metadata storage module which stores data disk metadata to indicate whether a virtual disk supports a fast rebuild, a plurality of disks, an Input Output (IO) controller which determines via the valid block data indication whether a block has valid stored data, and a RAID controller which is made aware of which of the plurality of blocks are in use so that only blocks that are in use are rebuilt after a disk drive failure. Each of the plurality of disks includes a plurality of blocks and each of the blocks includes a data portion and a block information portion. The block information portion includes a valid block data indication.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of a RAID controller.

FIG. 3 shows a block diagram of an organization of disks, virtual disks and RAID metadata.

FIG. 4 shows a block diagram of a block of data.

FIG. 5 shows a block diagram of flag and ID detection logic.

FIG. 6 shows a flow chart of a write operation.

FIG. 7 shows a flow chart of a foreground initialization operation.

FIG. 8 shows a flow chart of a fast rebuild operation.

### DETAILED DESCRIPTION

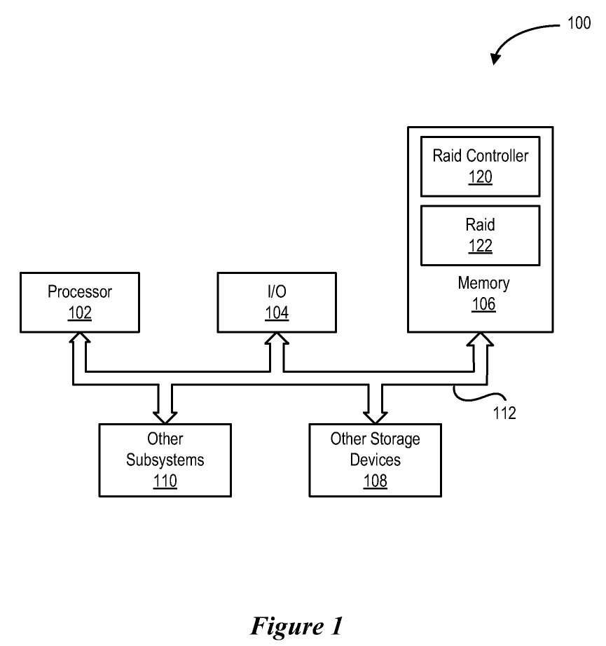

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 including volatile memory such as random access memory (RAM) and non-volatile memory such as a hard disk and drive, and other storage devices 108, such as an optical disk and drive and other memory devices, and various other subsystems 110, all interconnected via one or more buses 112.

The memory 106 includes a RAID controller 120 as well as a RAID system 122 which includes a plurality of drives configured as a RAID device.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

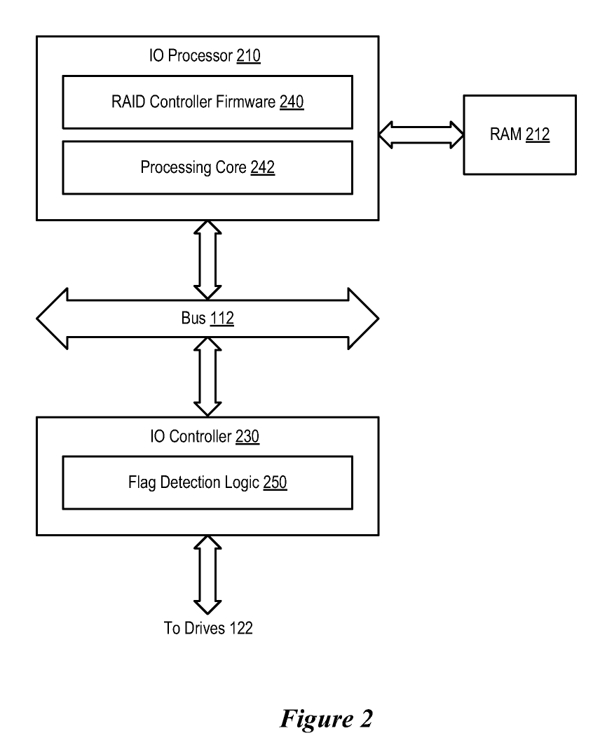

Referring to FIG. 2, a block diagram of a RAID controller 120 is shown. The RAID controller 120 includes an TO processor (IOP) 210. The IOP 210 is coupled to dedicated volatile memory (e.g., RAM) 212. The TOP 210 is also coupled to an IO controller 220 of the information handling system 100 via the bus 112. The IOP 210 handles all RAID functions and performs rebuilds, error recovery and any additional functions that are part of the feature set of the RAID system. The IOP 210 performs these operations independently of an operating system and thus enables many RAID tasks to execute outside of the operating system without affecting performance of the processor 102.

The IOP 210 includes a processing core 242 and executes RAID controller firmware 240. The TO controller 220 includes flag detection logic 250. The RAID controller firmware 240 supports metadata variables and flags, and a block flag.

The metadata variables and flags include a fast rebuild supported indication (FastRebuildSupported), as well as a virtual disk consistent indication (VirtualDiskConsistent). The fast rebuild supported indication is a flag that is stored in RAID metadata to indicate that the RAID system supports fast rebuild. The fast rebuild supported indication is useful during virtual disk migration when migrating to a controller that supports the fast rebuild feature to enable the fast rebuild feature for the virtual disk. The fast rebuild supported indication is meaningless to a controller that does not support the fast rebuild feature. The virtual disk consistent indication is a flag is stored in the RAID metadata to indicate whether the virtual disk is consistent.

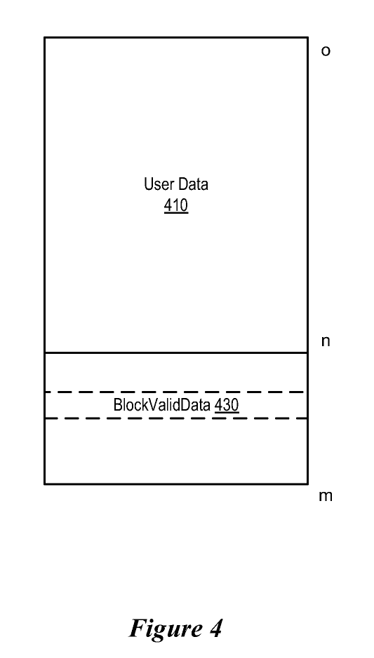

The block flag is a block valid data indication (BlockValidData). The block flag is defined for every block in a virtual disk and is stored in the region of the block outside the data area for the block (See FIG. 4). The block valid data indication indicates that a block contains valid data written by a host (blocks having this indication or flag set indicate that the block needs to be rebuilt). The block valid data indication is set by the RAID controller firmware 240 for every block that is written as a result of a host write operation. The block valid data indication is used by the rebuild task to determine if the stripe needs to be rebuilt.

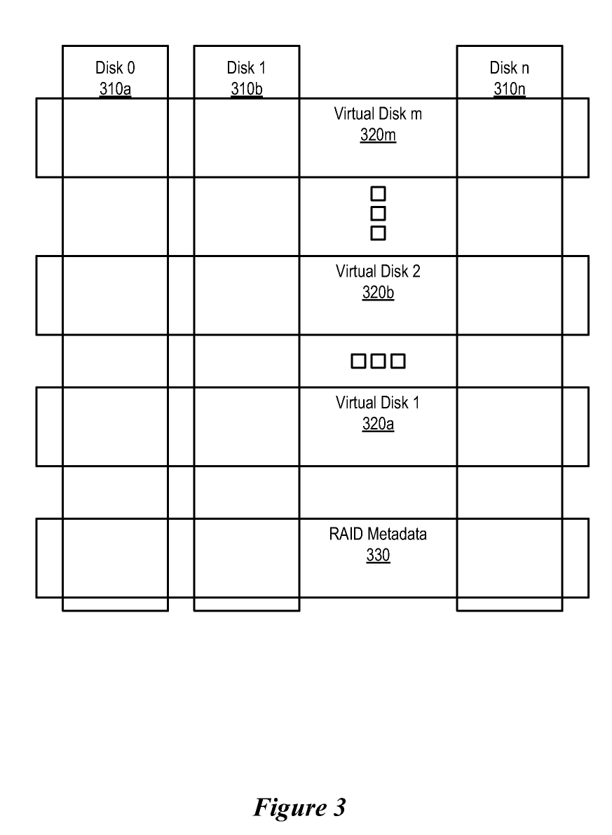

FIG. 3 shows a block diagram of a typical organization of disks, virtual disks and RAID metadata within a RAID system 122. More specifically, the RAID system 122 includes a plurality of disks 310 (Disk 0, Disk 1, Disk n) which are controlled via the RAID controller 120. The RAID system 122 also includes a plurality of virtual disks 320 (Virtual Disk 1, Virtual Disk 2, Virtual Disk m), which are stored across the plurality of disks 310. The RAID system 122 also includes RAID metadata 330 which is stored across the plurality of disks 310.

FIG. 4 shows a block diagram of a logical block of data. More specifically, a logical block of data includes user data 410 as well as block information 412 which is special control information for the block. The special control information is only accessible via special commands. The block information includes the block valid data indication.

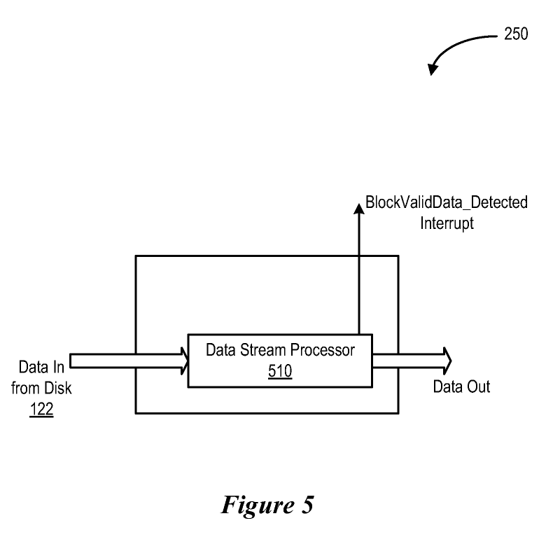

FIG. 5 shows a block diagram of flag detection logic 250. More specifically, the flag detection logic 250 includes a data stream processor 510. The data stream processor 510 receives data from the RAID disk system 112 and provides the data to the bus 112.

The data stream processor also generates a block valid data detected (BlockValidData-Detected) interrupt. The block valid data detected interrupt occurs when the processor detects block valid data value.

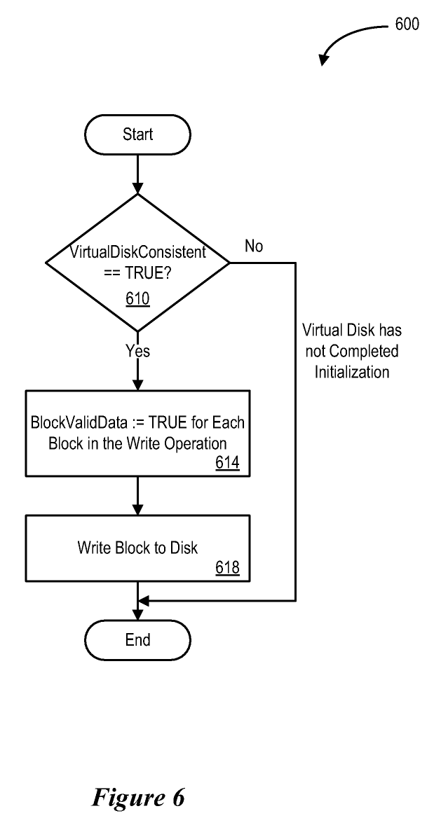

FIG. 6 shows a flow chart of a write operation 600 for the RAID system 112. More specifically, during a write operation 600, the virtual disk consistent indication is analyzed to determine whether the indication is set (i.e., is TRUE) at step 610. If the virtual disk consistent indication is set then the write operations are allowed to proceed on the virtual disk. Next, the block valid data indication is set true at step 614 and the block of data is written to the disk system 112 at step 618.

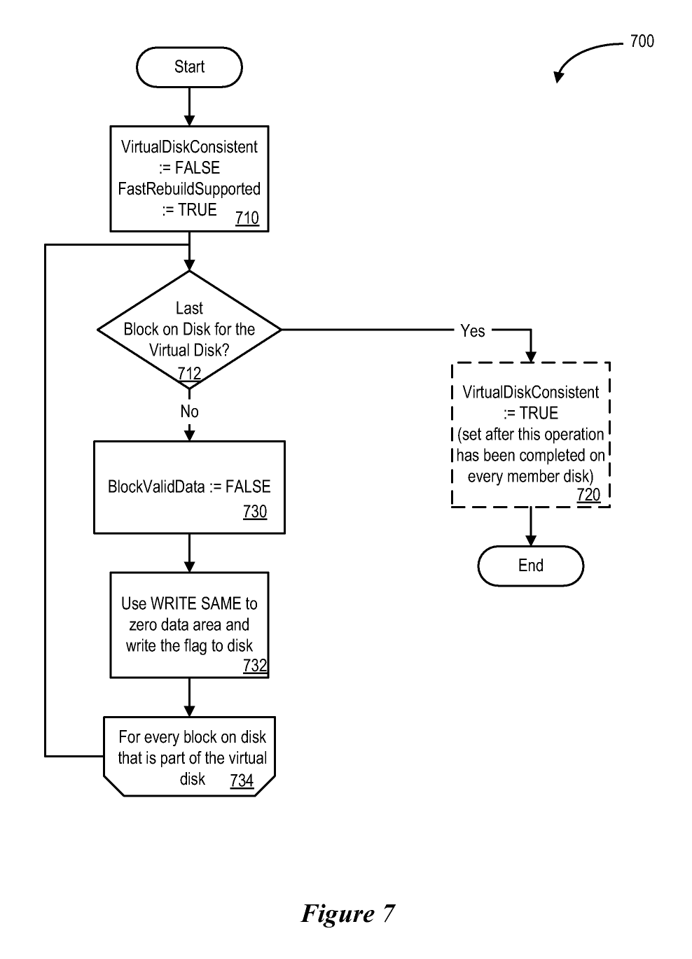

FIG. 7 shows a flow chart of a foreground initialization operation 700 with fast rebuild enabled. When fast rebuild is enabled, host IO operations are blocked until initialization completes. More specifically, during the foreground initialization operation starts by setting the virtual disc consistent value to false and the fast rebuild supported value to true at step 710. Next, the RAID logic determines whether the present block to be initialized is the last block on the disk for the virtual disk at step 712.

If the block is the last block on the disk, then the virtual disk consistent value is set to true at step 720 and the operation completes. The virtual disk consistent value is set to true after the foreground initialization is completed by every member disk within the RAID system 122.

If the block is not the last block on the disk, then the block valid data value is set to false at step 730. Next, a WRITE SAME operation is used to zero the data area and to write the block valid data flag and the data written on inconsistent stripe ID value to the disk at step 732. Steps 730 and 732 are repeated for every block that is on the disk that is part of the virtual disk at step 734.

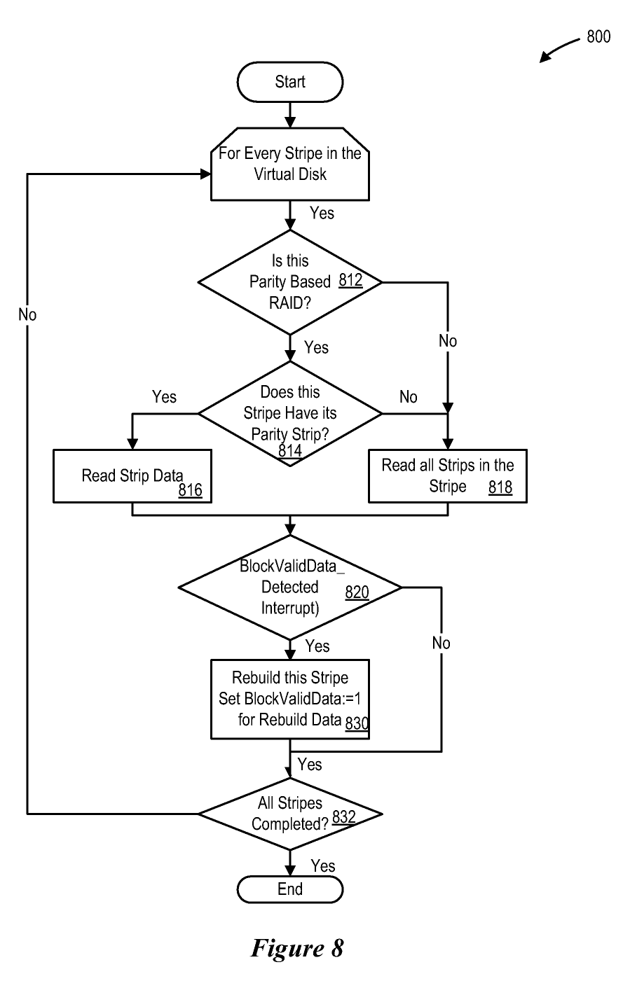

FIG. 8 shows a flow chart of a fast rebuild operation. For this rebuild operation, all flags have to be cleared on the disk to which rebuild is being performed prior to start of the rebuild (such as by using a WRITE SAME operation (a WRITE SAME operation does not require any data transfer to the disk)). The IOP 210 determines whether the RAID system 122 is a parity based RAID system at step 812.

If the RAID system 122 is a parity based RAID system, then the IOP 210 determines whether the stripe includes a corresponding parity stripe at step 814. If the stripe does include its corresponding parity strip then the IOP 210 reads the parity strip data at step 816. If the stripe does not include it corresponding parity strip, then the IOP 210 reads all strips in the stripe at step 818.

If, at step 812, the IOP 210 determines that the RAID system 122 is not a parity based RAID system, then the IOP 210 reads all strips in the stripe at step 818. After all strips in the stripe are read or the strip data is read, the IOP 210 determines whether the block valid data detected interrupt are present at step 820.

If the block valid data detected interrupt is generated, then the IOP rebuilds this stripe and sets the block valid data value to one for the rebuild data at step 830. Next, the IOP 210 determines whether all stripes have completed the rebuild operation at step 832.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include hardware and software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that any of the described functionality can be instantiated as logic within the information handling system.

Consequently, the invention is intended to be limited only by the spirit and scope of the appended claims, giving full cognizance to equivalents in all respects.

What is claimed is:

1. A fast rebuild mechanism for rebuilding a Redundant Array of Inexpensive Disks (RAID) system comprising
a disk metadata storage module, the disk metadata storage module storing data disk metadata to indicate whether a virtual disk supports a fast rebuild;
a plurality of disks, each of the plurality of disks including a plurality of blocks, each of the blocks including a data portion and an block information portion, the block information portion including a valid block data indication;
an Input Output (IO) controller, the IO controller determining via the valid block data indication whether a block has valid stored data; and,
a RAID controller, the RAID controller being made aware of which of the plurality of blocks are in use so that only blocks that are in use are rebuilt after a disk drive failure.

2. The fast rebuild mechanism of claim 1 wherein
the IO controller includes a storage controller.

3. The fast rebuild mechanism of claim 1 wherein
the block information portion is not accessible to an end user.

4. The fast rebuild mechanism of claim 1 wherein
the valid block data indication is set by the RAID controller for every block that is written as a result of a host write operation.

5. The fast rebuild mechanism of claim 1 wherein
the RAID controller performs an initialization operation to initialize each logical block and to indicate that the RAID system supports a fast rebuild operation.

6. The fast rebuild mechanism of claim 5 wherein
the initialization operation comprises a foreground initialization operation.

7. A method for performing a fast rebuild operation on a Redundant Array of Inexpensive Disks (RAID) system comprising
providing the RAID system with a disk metadata portion, the disk metadata portion storing a fast rebuild operation indication to indicate whether the RAID system supports a fast rebuild operation,
providing each logical block within the RAID system with a user data portion and a block information portion, the block information portion including a valid block data indication;
indicating that a logical block has valid data via the valid block data indication; and,
rebuilding only logical blocks that contain valid data after a disk drive failure based upon the fast rebuild operation indication and the valid block data indications.

8. The method of claim 7 further comprising
clearing the valid block data indication on blocks that are no longer in use within the RAID system.

9. The method of claim 7 wherein
the block information portion is not accessible to an end user.

10. The method of claim 7 wherein
the valid block data indication is set by the RAID controller for every block that is written as a result of a host write operation.

11. The method of claim 7 further comprising
performing an initialization operation to initialize each logical block and to indicate that the RAID system supports a fast rebuild operation.

12. The method of claim 11 wherein
the initialization operation comprises a foreground initialization operation.

13. An information handling system comprising:
a processor;
memory coupled to the processor; and,
a Redundant Array of Inexpensive Disks (RAID) system, the RAID system being capable of a fast rebuild operation, the RAID system comprising:
a disk metadata storage module, the disk metadata storage module storing data disk metadata to indicate whether a virtual disk supports a fast rebuild;
a plurality of disks, each of the plurality of disks including a plurality of blocks, each of the blocks including a data portion and an block information portion, the block information portion including a valid block data indication;
an Input Output (IO) controller, the IO controller determining via the valid block data indication whether a block has valid stored data; and,
a RAID controller, the RAID controller being made aware of which of the plurality of blocks are in use so that only blocks that are in use are rebuilt after a disk drive failure.

14. The information handling system of claim 13 wherein
the IO controller includes a storage controller.

15. The information handling system of claim 13 wherein
the block information portion is not accessible to an end user.

16. The information handing system of claim 13 wherein
the valid block data indication is set by the RAID controller for every block that is written as a result of a host write operation.

17. The information handling system of claim 13 wherein
the RAID controller performs an initialization operation to initialize each logical block and to indicate that the RAID system supports a fast rebuild operation.

18. The information handling system of claim 17 wherein
the initialization operation comprises a foreground initialization operation.
